(19) United States
(12) Patent Application Publication
(10) Pub. No.: US 2002/0028160 A1
(43) Pub. Date: Mar. 7, 2002

(54) Method and apparatus based on bundled capillaries for high throughput screening

(76) Inventors: Jianming Xiao, Fremont, CA (US); Shiping Chen, Rockville, MD (US); Yuling Luo, Castro Valley, CA (US); Anthony Chen, Sunnyvale, CA (US)

Correspondence Address: MORRISON & FOERSTER LLP, 755 PAGE MILL RD, PALO ALTO, CA, 94304-1018, US

(21) Appl. No.: 09/791,410

(22) Filed: Feb. 22, 2001

Related U.S. Application Data
(60) Provisional application No. 60/183,737, filed on Feb. 22, 2000.
(60) Provisional application No. 60/188,872, filed on Mar. 13, 2000.
(60) Provisional application No. 60/216,265, filed on Jul. 6, 2000.
(60) Provisional application No. 60/220,085, filed on Jul. 21, 2000.
(60) Provisional application No. 60/244,711, filed on Oct. 30, 2000.
(60) Provisional application No. 60/244,413, filed on Oct. 30, 2000.

(51) Int. Cl. B01J 19/00

(52) U.S. Cl. 422/100; 422/99; 422/102; 422/130; 422/131

(57) ABSTRACT

Disclosed are systems and methods involved in ultra high throughput screening of chemical compounds which have an affinity for or interact with a biological target. The invention utilizes an apparatus for ultra high throughput screening of chemical compounds for a biological target. The system is based on a capillary bundle that has two distinguishable ends. Capillaries on one end are connected to chemical compounds stored in discrete reservoirs such as micro titer plate wells; capillaries on the other end are tightly bound and then processed to form a two dimensional array that enable the parallel reactions of a target and many different compounds.

This invention claims the benefit of priority to U.S. Provisional Applications: U.S. Provisional Application Docket No. 473533000600, titled METHOD AND APPARATUS BASED ON BUNDLED CAPILLARIES FOR HIGH THROUGHPUT SCREENING by Jianming Xiao et al., filed on Feb. 16, 2001; 60/183,737, filed on Feb. 22, 2000; 60/188,872, filed on Mar. 13, 2000; 60/216,265, filed on Jul. 6, 2000; 60/220,085, filed on Jul. 21, 2000; 60/244,711, filed on Oct. 30, 2000; 60/244,413, filed on Oct. 30, 2000; U.S.; U.S. Provisional Application Docket No. 473533000700, titled LIQUID ARRAYS by Shiping Chen et al.; PCT Application Docket No. 473532000240, titled MICROARRAY FABRICATION TECHNIQUES AND APPARATUS by inventors Shiping Chen, Yuling Luo, and Anthony C. Chen; and PCT Application Docket No. 473532000270, titled MICROARRAY FABRICATION TECHNIQUES AND APPARATUS by inventors Shiping Chen, Yuling Luo, and Anthony C. Chen, the latter three having been filed on even date herewith. All of the above applications are incorporated by reference herein in their entireties as if fully set forth below.

### BACKGROUND OF THE INVENTION

The process of drug discovery is critically dependent upon the ability of screening efforts to identify lead compounds with future therapeutic potential. The screening efforts are often described as one of the bottlenecks in the process of drug discovery. The current high-throughput screening (HTS) technologies are based on microtitre plates, or microchips. Among them, the microtitre plates format has the highest throughput. The latest developments in high-throughput screening (HTS) technologies have achieved the followings:

1. speed<100,000/day (12 hrs)

2. sample volume>=0.5 ul

3. cost>=$1/data point

A system that has this kind of performance will need a few million dollars of equipment. And in addition, it needs more than one million dollars a month to operate. Thus, HTS is the privilege of a few big pharmaceutical companies.

It would be desired to provide a method to do HTS in much higher speed, less sample volume, and much lower price to operate.

### SUMMARY

The invention provides systems and methods involved in ultra high throughput screening of chemical compounds which have an affinity for or interact with a biological target, as described herein.

The invention in one embodiment provides an apparatus for ultra high throughput screening of chemical compounds for a biological target. The system is based on a capillary bundle that has two distinguishable ends. Capillaries on one end are connected to chemical compounds stored in discrete reservoirs such as micro titre plate wells; capillaries on the other end are tightly bound and then processed to form a two dimensional array that enable the parallel reactions of a target and many different compounds. The apparatus comprises a fluid delivery subsystem, a reaction chamber and a readout subsystem.

The capillary bundle for library compounds delivery can be one as described in GenoSpectra's pending U.S. patent application Ser. Nos. 60/244,711, filed on Oct. 30, 2000 or 60/244,413, filed on Oct. 30, 2000, which are incorporated by reference in their entirety as if fully put forth herein. 10³-10⁶ capillaries of a few meters long are bundled together, orderly or randomly. The bundle has two distinguishable ends, the unbound end is referred as the input end, the bound end is referred as the output end. Each capillary at the input end is connected to a reservoir, such as a microtitre plate well, that holds a chemical compound in a way that the capillary can draw fluid from the well. The output end of the capillary either contacts or forms the surface of a reaction chamber, as discussed more fully below. The chemical compounds in liquid state are delivered by applying pressure to the reservoirs (as illustrated in FIG. 2) or by gravity (as illustrated in FIG. 3), for instance, or by any of the other methods discussed in GenoSpectra's pending U.S. patent applications discussed above.

There are a number of reaction chamber designs possible. In one, chemical reactions take place in the tips of the capillaries at their output ends. In another, chemical reactions take place on a through hole plate, such as the one disclosed in U.S. Pat. No. 6,027,873, to Schellenberger et al., which is incorporated by reference in its entirety as if fully set forth herein. These bundled capillaries deliver chemical compounds from a library in the methods described below, although the bundled capillaries may deliver other compounds if desired.

Interaction of the target and chemical compounds can be detected by fluorescence emission (intrinsic or extrinsic probes) of the target system. The detection system can be a CCD based fluorescence imaging system or a scanning based fluorescence system. In the second approach, absorption of samples can also be measured by placing a light source and a detector on different sides of the through hole plate.

### BRIEF DESCRIPTION OF THE DRAWINGS

FIG. 1 is a perspective view of a capillary bundle in accordance with the present invention.

FIG. 2 illustrates a pressurized fluid delivery subsystem in which reservoirs contained within an enclosure are capable of being pressurized to delivery compounds to the output ends of the capillary bundle.

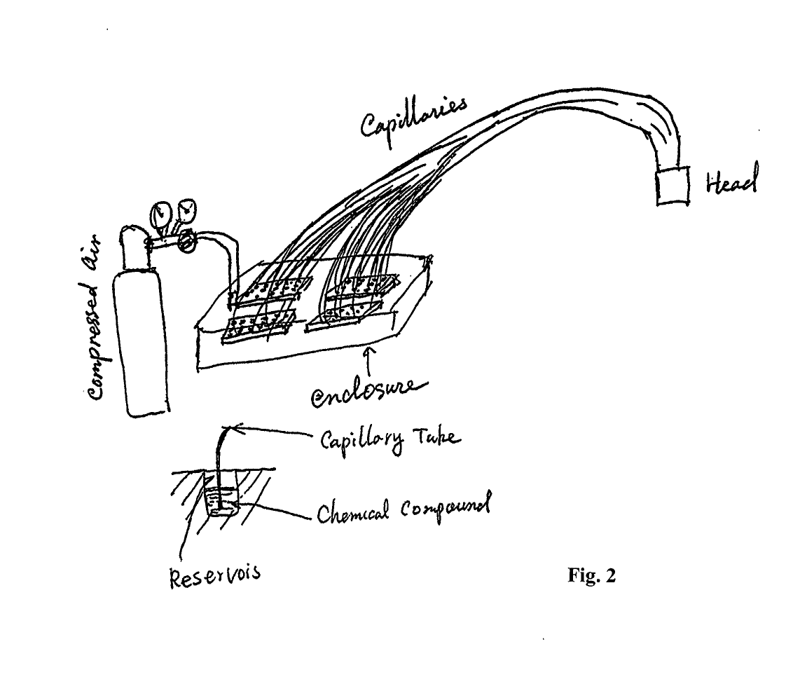

FIG. 3 illustrates a gravity fluid delivery subsystem that delivers fluid to a separate reaction chamber.

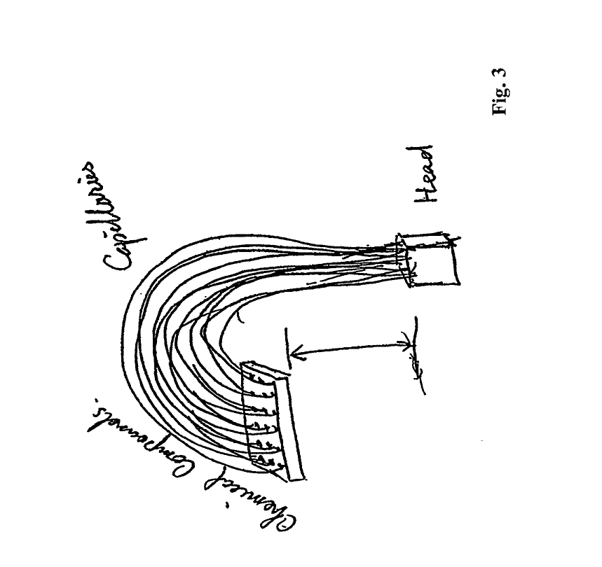

FIG. 4 illustrates a reaction chamber connected to the fiber bundle.

FIG. 5 depicts a reaction chamber separated from the fiber bundle.

FIG. 6 depicts a fluorescence detection subsystem.

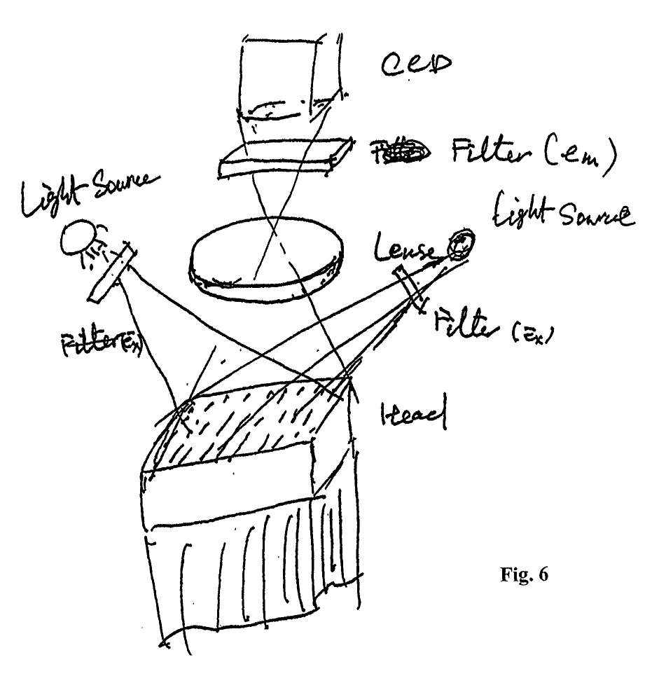

FIG. 7 is a diagram of an application of the present invention to an enzyme based HTS assay.

FIG. 8 is a diagram of an application of the current invention to a cell based THS assay.

FIG. 9 illustrates a method for fiber bundle fabrication.

FIG. 10 depicts a mini pore plate.

FIG. 11 depicts a device based on the reaction head approach.

FIG. 12 depicts one cycle of an extra high throughput system.

FIG. 13 depicts one cycle of an assay for screening using a protein array or cell array.

### DETAILED DESCRIPTION OF THE INVENTION

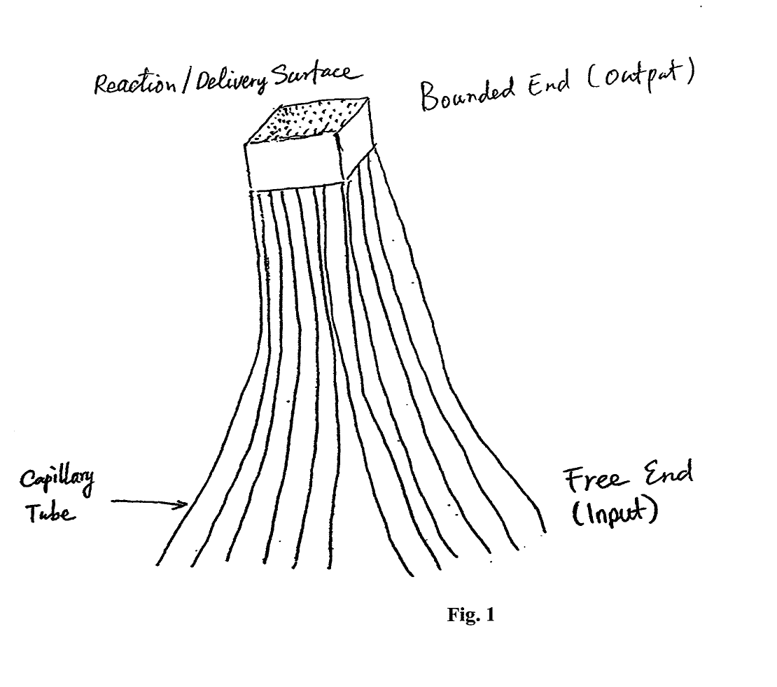

A capillary bundle as depicted in FIG. 1 is fabricated by using e.g. 10³ to 10⁶ of 50-200 micrometer OD, 10-100 micrometer ID capillary tubes, such as those used for capillary electrophoresis. The tubes are bound at one end to form a reaction/delivery head. The tubes may be gathered in a random or orderly fashion and bound, as discussed in GenoSpectra's U.S. patent applications discussed above. The minimum number of tubes typically depends upon the number of compounds in a chemical library (preferably 10⁵-10⁶).

When the reaction/delivery head is formed of a random bundle of capillaries, the capillaries are bound together with adhesive or heat to fuse them, for example, without caring about the order of each capillary. The position of each capillary is then identified in the tagging process described in GenoSpectra's U.S. patent applications discussed above.

Or, the position of each capillary may be determined using the following sequence. During the tagging process to register the input end of a capillary to its corresponding output end, all tubes are filled with a higher index fluid (than that of fused silica), such as CCl₄, to create light guides inside the tubes. When the free end of a tube is illuminated by a light source, its bound end is identified by using a light detector. This process is repeated until all capillaries' positions are located.

When the reaction/delivery head is formed of an ordered bundle of capillaries, any of the methods described in GenoSpectra's pending applications discussed above can be used.

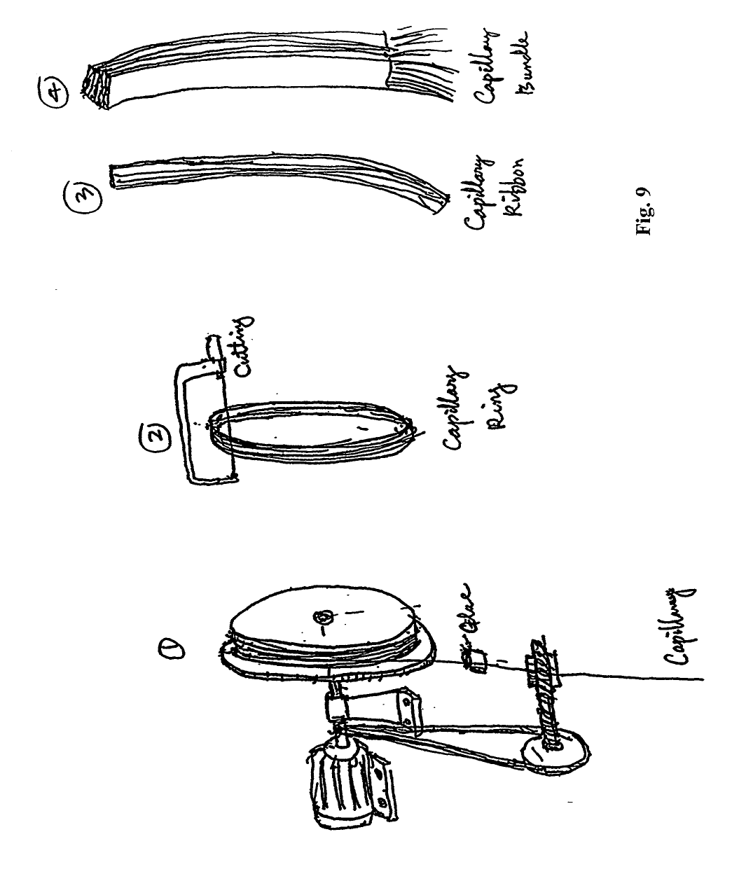

In addition, a new method as illustrated in FIG. 9 can be used to form the ordered bundle. A capillary tube is wound on a drum, which for example has a circumference greater than or equal to the desired length of the bundle, for many rounds. A flexible adhesive is applied to the capillary while winding. After the adhesive is cured, the capillary ring is cut using, e.g., a saw (as shown in FIG. 9) and opened out to make a capillary ribbon. The cut ribbon may itself be cut further to form additional capillary ribbons, if desired. Many of these ribbons are stacked together to form an orderly bundle in which each individual ribbon is inserted into a well, so that all of the capillaries in that particular ribbon transport a particular fluid, and each ribbon transports a different fluid.

The bound end of the capillary bundle can be fabricated as a delivery head, in which the output end delivers fluid to a separate reaction chamber, or the bound end of the capillary bundle can form a reaction surface in which are formed microwells in which the reaction occurs. Followings are details of these two approaches.

In the delivery head approach, the bound end is first cut by a diamond wire saw, and the bound end is then polished on a polishing machine. The finished surface is coated with two layers of material. The inner layer is a conductive material, such as aluminum or gold, which can be used to help convey chemical compounds to the output end and to the reaction chamber as described in GenoSpectra's pending U.S. applications discussed above, and the outer layer is a hydrophobic material, such as a fluorocarbon polymer such as polytetrafluoroethylene.

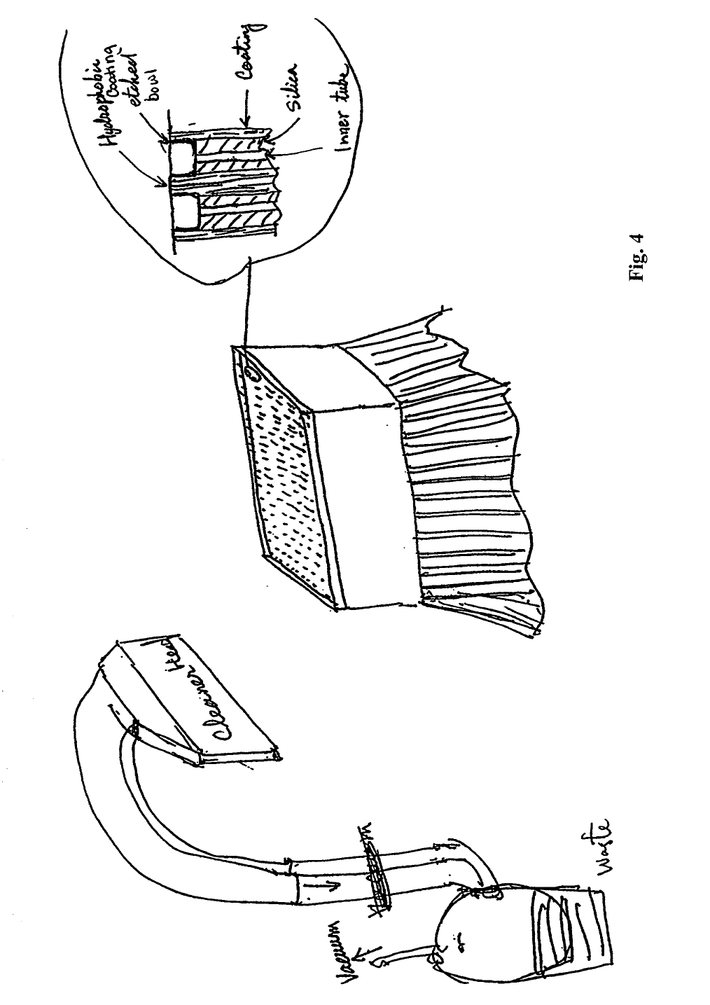

In the reaction head approach, the bound bundle is also cut and polished. Then, part of the material forming the inner layer of the capillary, fused silica, is removed by chemical etching the portion of the capillary doped with metals that increase the etch rate of the doped region over that of the undoped region, as described in GenoSpectra's U.S. patent applications discussed above. Consequently, a small reaction chamber is formed at the tip of each capillary, as illustrated in the portion of FIG. 4 providing an enlargement of two adjacent microwells or chambers. These chambers are opened on the surface of the reaction head as shown in FIG. 4. After etching, the surface of the reaction head is coated with a layer of hydrophobic material, such as a fluorocarbon polymer such as polytetrafluoroethylene. A wall of e.g. a polymer of that extends a few mm above the reaction surface can also be added to the reaction head by wrapping a film of the polymer and adhering it to the reaction head. This wall enables samples or buffers to flood the whole reaction surface and enter the chambers formed in the reaction surface. Since each chamber is located at the output end of an individual capillary of the bundle, chemical compounds can be delivered from the microtitre plates through the capillaries and into the chambers.

Following is description of how these two approaches work.

Delivery head approach

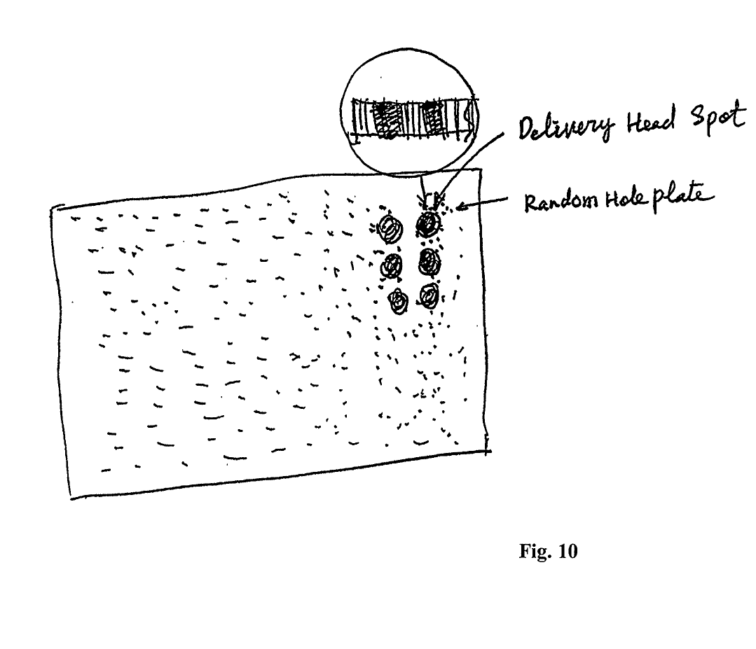

Through hole plates (such as those described in U.S. Pat. No. 6,027,873) are used in one such system. The holes in the through plate are at the exact pitch as the delivery head but have a larger diameter than the capillaries of the delivery head. Or, the holes in the through plate can be randomly distributed and have a diameter smaller (⅕-1/10, for example) than that of the capillaries (as illustrated in FIG. 10), such that a number of adjacent holes in the through head are filled by a particular liquid capillary. Homogenous samples are loaded into the through hole plate by immersing the plate in the sample. Capillary effect then draws the liquid sample into the holes of the through plate. Chemical compounds, on the other hand, are delivered by contacting the through hole plate with the delivery head connected to the chemical compound library that is enclosed in a pressure chamber.

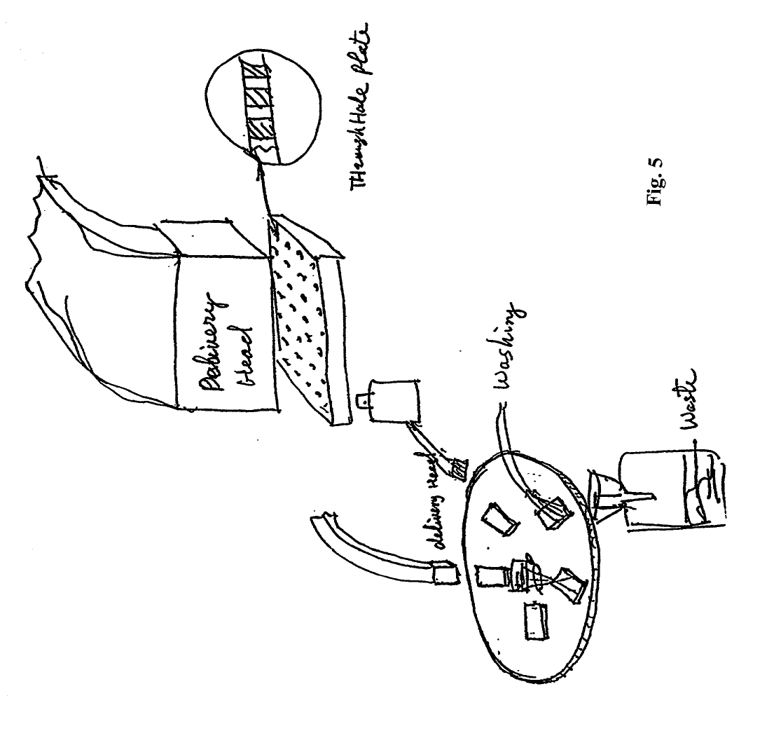

Five of such through-hole plates are installed in a rotational or translation platform in the system illustrated in FIG. 5. One is loading sample (which, for example, will be changed in the next step to provide a different sample to the next reaction chamber placed in contact with the sample), the second one is adding chemical compounds (always connected to the same library), the third one is incubating, the fourth one is being scanned to read out whether association or reaction has occurred, and the fifth one is being washed. All these steps are carried out simultaneously. And rotation/translation of the platform enables the screening process for different samples against the same chemical compound library.

Reaction head approach

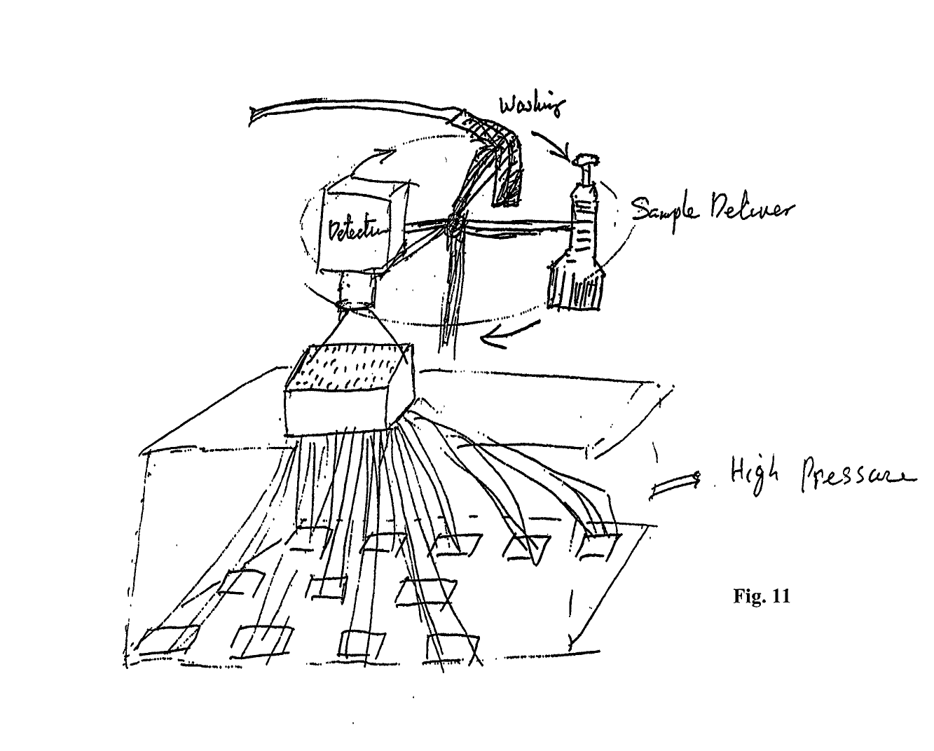

In this approach, buffer is first filled in the reaction chamber, by dispensing or by flowing, to wash the reaction surface. Then the buffer is vacuumed away from the reaction chamber. This process is repeated as needed to provide a clean reaction surface. (See FIG. 4 for an illustration of a cleaner head.) Next, sample fills the reaction chamber. A regulator such as a flat piece of rubber or metal is then used to wipe off all portions of samples higher than the wall of each small reaction chamber. Chemical compounds are then delivered by applying a positive pressure to the chemical library enclosure or by increasing the height difference of the compound reservoirs and the reaction head, and the reaction head is again swiped clean of any liquid displaced onto the surface of the reaction head using the regulator. Then, the apparatus is left alone for incubation. When the reactions are complete, a detecting device, such as a fluorescence scanner, is moved to the top of the reaction head to read out signals (see FIG. 11).

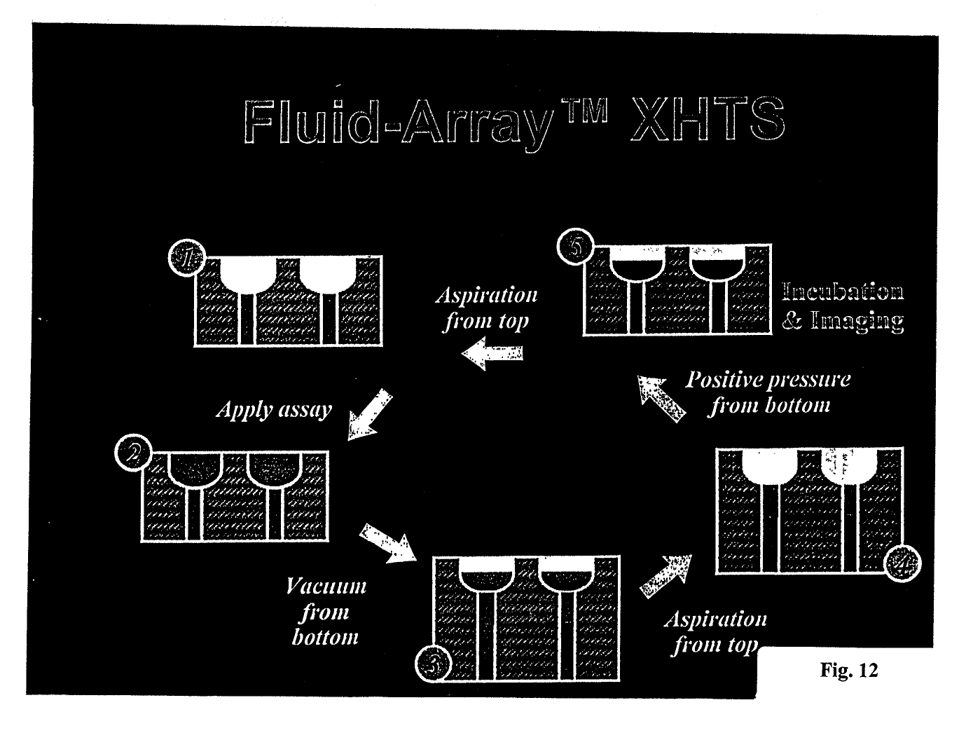

An alternate method of filling the reaction chambers is illustrated in FIG. 12, illustrating an extra high throughput system (XHTS). In step one, any fluid in the chambers is aspirated out using vacuum. In step 2, the sample is applied to the reaction head to fill the chambers. Subsequently, in step 3, a vacuum is applied to the capillaries at their inlet ends to draw some but not all of the sample into the capillaries of the reaction head. (Alternatively, a pressure may be applied to the reaction chambers from above to push a portion of the sample from the chambers into the capillaries.) The portions of sample remaining in the chambers are aspirated from the chambers using e.g. the vacuum head illustrated in FIG. 4. Subsequently, the portions of sample remaining in the capillaries after aspiration as well as some of the chemical compounds from the capillaries are pushed into the reaction chambers using a positive pressure applied at the inlet side of the capillaries (or a negative pressure applied at the chambers). This action promotes turbulent or forced mixing of the sample with the chemical compounds, which would otherwise have to diffuse into one another. The turbulent or forced mixing reduces the time needed to mix and react the sample and chemical compounds of the library. Once scanning is completed, the mixture is e.g. aspirated from the reaction chambers, the reaction chambers are washed as described previously, and the reaction head is placed into another cycle as just described.

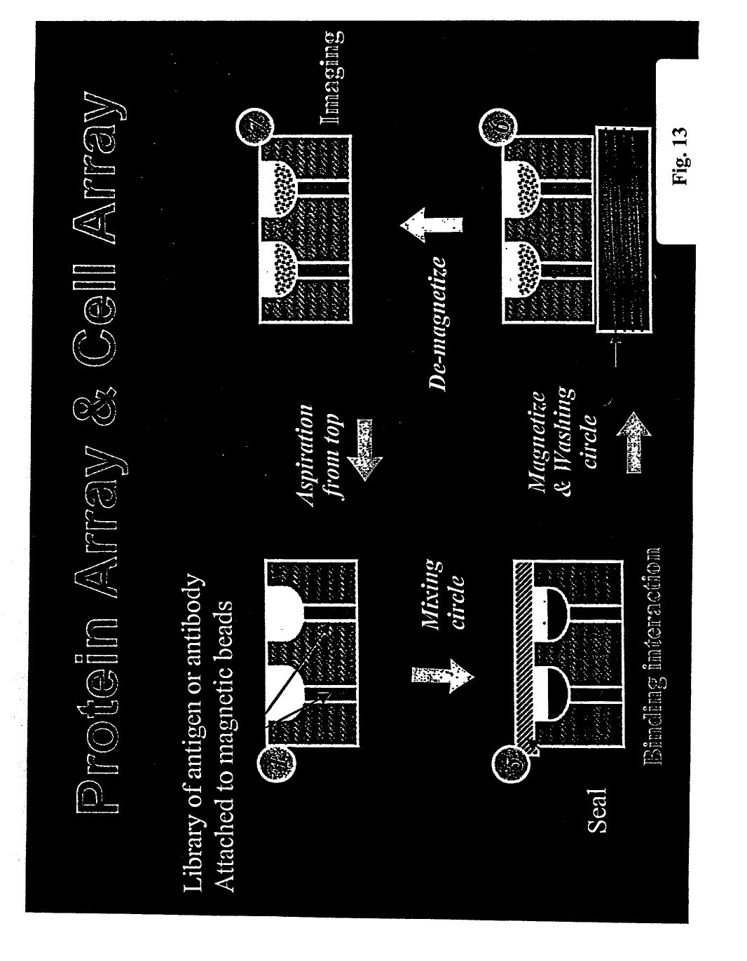

FIG. 13 illustrates an assay involving protein arrays or cell arrays. A library of antigens or antibodies is attached to magnetic beads as discussed in GenoSpectra's patent applications discussed above. The method illustrated in FIG. 12 and discussed immediately above is used to mix the sample and proteins or cells of the library. The reaction head may be sealed using e.g. a glass or polymeric plate as illustrated at step 5, and the reaction head may be transported to a separate magnetic head, where the plate is removed, a washing fluid is placed into the chambers as part of the washing cycle, the beads are subjected to a magnetic field generated by the head (e.g. an electromagnet), and the fluid is removed by aspirating it but the beads are held in place by the magnetic field. The system is then demagnetized, and the reaction head is moved to a position beneath e.g. a fluorescence scanner. Once scanning is completed, the magnetic beads are e.g. aspirated from the reaction chambers, the reaction chambers are washed as described previously, and the reaction head is placed into another cycle as just described.

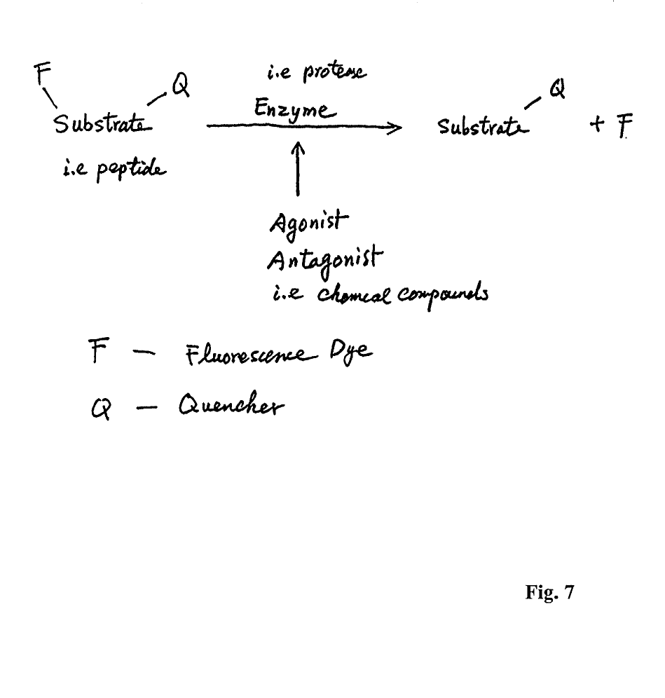

FIG. 7 illustrates an enzyme based HTS assay. As is apparent to one of ordinary skill from this figure, a substrate such as a peptide, which has a fluorescent moiety and a quencher that quenches the fluorescent moiety, and an enzyme such as protease, contact the surface of the reaction head, which delivers agonists and/or antagonists to the reaction head. The fluorescent moiety is cleaved from the substrate, allowing the dye to fluoresce to identify interaction of the agonist/antagonist with this substrate.

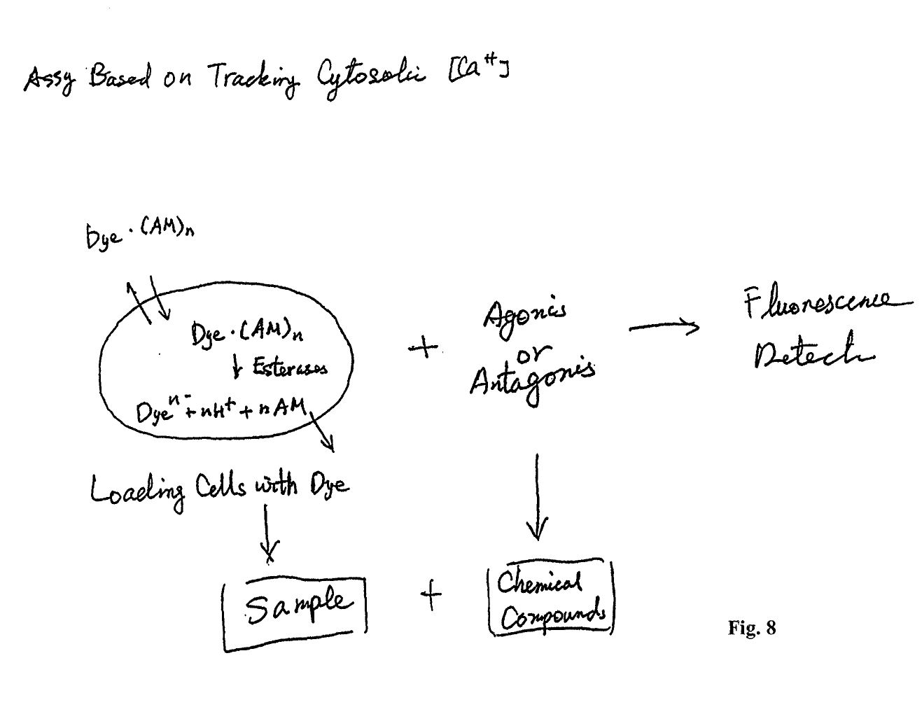

FIG. 8 illustrates a cell based THS assay that can be performed using the invention. As is apparent to one of ordinary skill from this figure, agonists and/or antagonists are placed in a library and delivered to the reaction head via the capillaries of the delivery or reaction head. The sample is prepared as illustrated, and the sample is placed in the reaction head as described above. Once sufficient time has passed that the sample has reacted with the agonists and/or antagonists, the reaction head is scanned using a fluorescence detector to determine the presence or absence of binding or reaction.

Potential of the invention

A system of this invention has substantial advantages over existing systems. A system having, e.g., 5×10⁵ capillary tubes can process approximately 1,200,000,000 data points/day (8 hrs), with a substantially reduced cost in reading each data point.

What is claimed is:

1. An apparatus for ultra high throughput screening of chemical compounds for a biological target, comprising a capillary bundle having a first end and a second end, said first end being attached to a reaction chamber.

2. An apparatus for ultra high throughput screening of chemical compounds for a biological target, comprising a capillary bundle having a first end and a second end, said first end forming a reaction chamber.
